(19) United States
(12) Patent Application Publication
(10) Pub. No.: US 2026/0211938 A1
(43) Pub. Date: Jul. 23, 2026

(54) PROCESSING APPARATUS, PROCESSING METHOD, AND NON-TRANSITORY COMPUTER-READABLE MEDIUM

(71) Applicant: NEC Corporation, Tokyo (JP)

(72) Inventors: Noboru YOSHIDA, Tokyo (JP); Atsushi HONDA, Tokyo (JP); Yoshihiro KAJIKI, Tokyo (JP); Takayuki KASE, Tokyo (JP); Ikumu YASUDA, Tokyo (JP); Takumi OZAKI, Tokyo (JP); Jianquan LIU, Tokyo (JP); Tingting DONG, Tokyo (JP)

(73) Assignee: NEC Corporation, Tokyo (JP)

(21) Appl. No.: 19/157,728

(22) PCT Filed: Jan. 31, 2024
(86) PCT No.: PCT/JP2024/002999

§ 371 Date: Aug. 19, 2025

(30) Foreign Application Priority Data
Mar. 29, 2023 (JP) 2023-052946

(51) Int. Cl. G06F 16/532; G06F 16/535

(52) U.S. Cl. CPC G06F 16/532; G06F 16/535

(57) ABSTRACT

The present invention provides a processing device which includes: a reception unit that receives the input of appearance features of a plurality of items of a person to be tracked on the basis of the testimony of an eyewitness; a question determination unit that determines, on the basis of the input details of the appearance features, a question to be posed to the eyewitness regarding the person to be tracked; a question unit that outputs the question and receives an answer to the question; and a search query generation unit that, on the basis of the answer to the question, generates a search query for searching for the person to be tracked in an image.

### TECHNICAL FIELD

The present invention relates to a processing device, a processing method, and a program.

### BACKGROUND ART

A technique according to the present invention is disclosed in PTL 1. The technique disclosed in PTL 1 is a technique for searching for a suspect or a criminal of an incident or an accident. In this technique, a police operator listens to information regarding a suspect or a criminal from a reported witness, and inputs the information to a system as a search key. The system searches for a suspect or a criminal in an image based on the search key. The police operator can further input, as a search key, information additionally heard from the reported witness to the system. The system searches for the suspect or the criminal in the image based on the search key including the additional information.

### CITATION LIST

### Patent Literature

PTL 1: JP 2019-36872 A

### SUMMARY OF INVENTION

### Technical Problem

In a case where a tracking target person is searched for in an image based on appearance features, the tracking target person can be accurately searched for depending on the search key. For example, in a case where the appearance features of more items are included in the search key, the tracking target person can be accurately searched for. In a case where the search key includes an appearance feature of an item effective by narrowing down search results, the tracking target person can be accurately searched for. Examples of the plurality of items of appearance features include, but are not limited to, sex, age, hairstyle, body shape, presence or absence of a hat, type of a hat, color of a hat, presence or absence of glasses, a type of glasses, and color of the glasses.

The present inventors have found the following problems in a case where a search key is generated based on a statement of a witness.

Based on her or his own memory, the witness testifies about the appearance features of the tracking target person. In such cases, there may be appearance features actually remembered by the witness, but not included in the statement. For example, there may be appearance features that have not been included in the statement because the appearance features are not thought during the statement. There may be appearance features that have not been included in the statement because the witness has not thought that the appearance features are important and the witness has not intentionally testified the appearance features.

The tracking target person is likely to be searched for more accurately because appearance features remembered by the witness but not included in the statement are included in the search key. PTL 1 does not disclose a solution to the problem.

In view of the above-described problem, an object of the present invention is to provide a processing device, a processing method, and a program for executing assistance in which appearance features remembered by a witness but not included in a statement are included in a search key.

### Solution to Problem

According to one example aspect of the present invention,
there is provided a processing device including
reception means for receiving an input of appearance features of a plurality of items about a tracking target person based on a witness's statement,
question determination means for determining, based on an input content of the appearance features, a question to inquire the witness about the tracking target person,
question means for outputting the question and receiving an answer to the question, and
search query generation means for generating a search query for searching for the tracking target person in an image based on the answer to the question.

According to one example aspect of the present invention,
there is provided a processing method causing one or more computers to execute
receiving an input of appearance features of a plurality of items about a tracking target person based on a witness's statement,
determining, based on an input content of the appearance features, a question to inquire the witness about the tracking target person,
outputting the question and receiving an answer to the question, and
generating a search query for searching for the tracking target person in an image based on the answer to the question.

According to one example aspect of the present invention,
there is provided a program for causing a computer to function as
reception means for receiving an input of appearance features of a plurality of items about a tracking target person based on a witness's statement,
question determination means for determining, based on an input content of the appearance features, a question to inquire the witness about the tracking target person,
question means for outputting the question and receiving an answer to the question, and
search query generation means for generating a search query for searching for the tracking target person in an image based on the answer to the question.

### ADVANTAGEOUS EFFECTS OF INVENTION

According to an example aspect of the present invention, a processing device, a processing method, and a program for executing assistance in which appearance features remembered by a witness but not included in a statement are included in a search key.

### BRIEF DESCRIPTION OF DRAWINGS

The above-described object and other objects, features, and advantages will be further clarified by the following public suitable embodiments and accompanying drawings.

FIG. 1 It is a diagram illustrating an example of a functional block diagram of a processing device.

FIG. 2 It is a diagram illustrating an example of a hardware configuration of the processing device.

FIG. 3 It is a diagram schematically illustrating an example of information processed by the processing device.

FIG. 4 It is a flowchart illustrating an example of a processing flow of the processing device.

FIG. 5 It is a diagram illustrating an example of a functional block diagram of the processing device.

FIG. 6 It is a flowchart illustrating an example of a processing flow of the processing device.

### EXAMPLE EMBODIMENT

Hereinafter, example embodiments of the present invention will be described with reference to the drawings. In all the drawings, the same components are denoted by the same reference numerals, and description thereof will be omitted as appropriate.

### First Example Embodiment

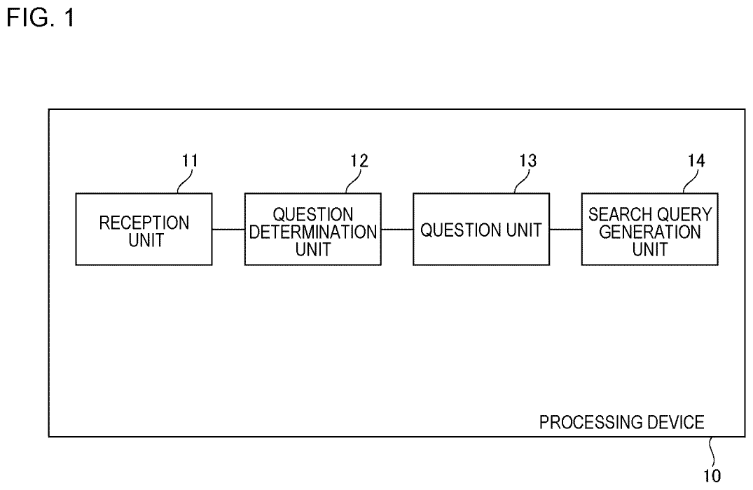

FIG. 1 is a functional block diagram illustrating an outline of a processing device 10 according to a first example embodiment. The processing device 10 includes a reception unit 11, a question determination unit 12, a question unit 13, and a search query generation unit 14.

The reception unit 11 receives an input of appearance features of a plurality of items of a tracking target person based on a witness's statement. The question determination unit 12 determines a question to inquire the witness about the tracking target person based on the input content of the appearance features. For example, the question determination unit 12 determines a question for inquiring about appearance features of items that have a correlation with input items of the appearance features. The question unit 13 outputs the determined question and receives an answer to the question. The search query generation unit 14 generates a search query for searching for the tracking target person in the image based on the answer to the question.

In the processing device 10 that questions such a witness and generates the search query based on the answer, appearance features remembered by the witness but not included in the statement can be included in the search key.

The processing device 10 determines a question to inquire the witness about the tracking target person based on appearance features of a plurality of items of the tracking target person input based on the witness's statement. In the processing device 10, it is possible to accurately determine a question regarding the appearance features that are highly likely to be remembered by the witness.

Even when there are appearance features that the witness has not stated because the witness did not think the appearance features important, it is considered that the witness states about the appearance features if the witness is questioned about the appearance features. In a case where the processing device 10 is configured to output a question and receives an answer to the question, appearance features not stated by the witness can be obtained by questioning.

### Second Example Embodiment

### “Overview”

The processing device 10 according to a second example embodiment is obtained by embodying the processing device 10 according to the first example embodiment. That is, the processing device 10 determines a question to inquire the witness about the tracking target person based on the appearance features of the plurality of items of the tracking target person input based on the witness's statement. Then, the processing device 10 generates a search query for searching for the tracking target person in the image based on the answer to the question. Hereinafter, a configuration of the processing device 10 will be described in detail.

“hardware Configuration”

An example of a hardware configuration of the processing device 10 will be described. Each functional unit of the processing device 10 is implemented by any combination of hardware and software. It is to be understood by those skilled in the art that there are various modifications of an implementation method and the device. The software includes a program stored in advance from a stage of shipping the device, a program downloaded from a recording medium such as a compact disc (CD), a server on the Internet, or the like.

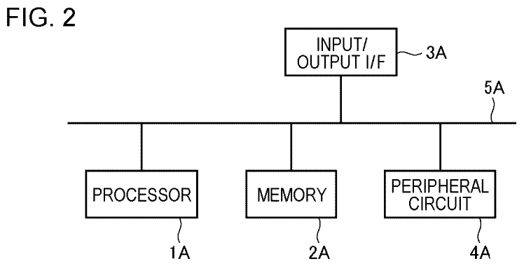

FIG. 2 is a block diagram illustrating a hardware configuration of the processing device 10. As illustrated in FIG. 2, the processing device 10 includes a processor 1A, a memory 2A, an input/output interface 3A, a peripheral circuit 4A, and a bus 5A. The peripheral circuit 4A includes various modules. The processing device 10 may not include the peripheral circuit 4A. The processing device 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is, for example, an arithmetic processing unit such as a CPU or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, or the like and a camera, and an interface for outputting information to an output device, an external device, an external server, or the like. The input/output interface 3A includes an interface for connection to a communication network such as the Internet. The input device is, for example, a keyboard, a mouse, a microphone, a physical button, a touch panel, or the like. The output device is, for example, a display, a speaker, a printer, a mailer, or the like. The processor 1A can issue a command to each module and execute calculation based on a calculation result.

“functional Configuration”

Next, a functional configuration of the processing device 10 according to the present example embodiment will be described in detail. FIG. 1 illustrates an example of a functional block diagram of a processing device 10 according to the present example embodiment. As illustrated, the processing device 10 according to the present example embodiment includes a reception unit 11, a question determination unit 12, a question unit 13, and a search query generation unit 14.

The reception unit 11 receives an input of appearance features of a plurality of items of a tracking target person based on a witness's statement. The reception unit 11 receives an input via an input device such as a keyboard, a touch panel, a microphone, or a physical button, or a predetermined user interface (UI) screen. As the user who executes the input, a person who tracks the tracking target person, an affiliation member of an organization, or the like is assumed. Additionally, the input may be executed by the witness herself or himself.

The “plurality of items” relates to features of a person that can be extracted from the appearance, that is, features of a person that can be extracted through image analysis. Examples of the plurality of items include, but are not limited to, sex, an age, hairstyle, a body shape, presence or absence of a hat, a type of hat, color of the hat, presence or absence of glasses, a type of glasses, color of glasses, color of clothes, design of clothes, color of belongings, and design of belongings. The user inputs an appearance feature of at least one item among the plurality of items.

The appearance features that can be taken by the item “sex” are male and female.

The appearance features that can be taken by the item “age” may be age itself or ages such as teenagers and twenties.

The appearance features that can be taken by the item “hairstyle” are classifications of hairstyles such as a shaved head, a semi-long hairstyle, and the like.

The appearance features that can be taken by the item “body shape” are classifications of body shapes such as a thin type, a plump type, and the like.

The appearance feature for the item “presence or absence of a hat” is present (worn) or absent (not worn).

The appearance feature for the item “type of the hat” is classification of the hat such as a cap, a hunting cap, and a knit hat.

The appearance feature for the item “color of the hat” may be a single color such as red or black, or may be a combination of a plurality of colors such as red and black.

The appearance feature for the item “presence or absence of glasses” is present (worn) or absent (not worn).

The appearance feature for the item “type of glasses” is classification based on the shape of a frame or rim. For example, an oval, a square, a round, a full rim, a half rim, no rim, and the like are exemplified.

The appearance feature for the item “color of glasses” may be a single color such as red or black or may be a combination of a plurality of colors such as red and black.

The appearance features that can be taken by the item “color of clothing” may be a single color such as red or black, or may be a combination of a plurality of types of color such as red and black.

The appearance features that can be taken by the item “design of clothing” are classifications of clothing such as miniskirts, pants, T-shirts, and coats. The appearance features that can be taken by the item “design of clothing” may be obtained by further subdividing the classification of clothing. For example, the coats can be subdivided like a down coat or a duffle coat. Trousers and outerwear can be subdivided into formal and casual trousers and outerwear.

The appearance features that can be taken by the item “color of belongings” may be a single color such as red or black, or may be a combination of a plurality of types of color such as red and black.

The appearance features that can be taken by the item “design of belongings” are classification of belongings such as a bag and an umbrella. The appearance features that can be taken by the item “design of belongings” may be obtained by further subdividing the classification of the belongings. For example, bags can be subdivided into a backpack or a business bag. In a case where a person possesses a plurality of personal belongings, a plurality of features can be taken.

The question determination unit 12 determines a question to inquire the witness about the tracking target person based on the input content of the appearance features received by the reception unit 11.

Specifically, the question determination unit 12 specifies an item of which the appearance feature has been input. Then, the question determination unit 12 determines a question based on the specified item.

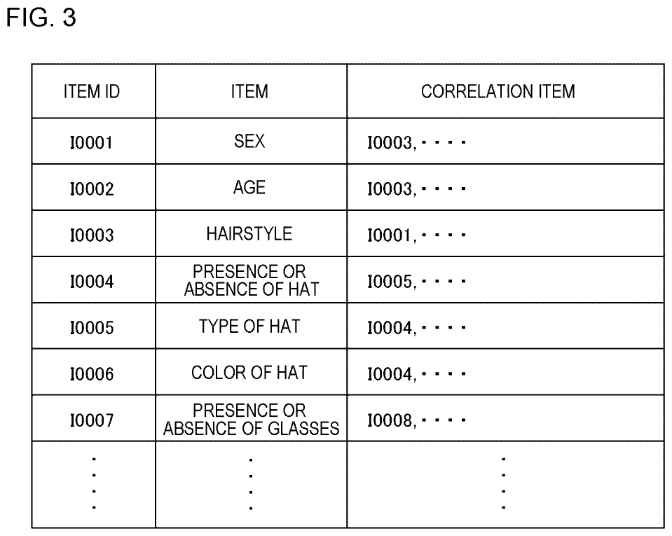

More specifically, as illustrated in FIG. 3, correlation information indicating a correlation between a plurality of items is generated in advance and stored in the processing device 10. In FIG. 3, the item that has the correlation with each item is registered in association with each item. The question determination unit 12 extracts an item that has the correlation with the item of which the appearance feature is input based on the correlation information. The question determination unit 12 determines a question to inquire about the appearance feature of the extracted item, specifically, the appearance feature of the item of the tracking target person. For example, in a case where the item “color of the hat” is extracted as an item that has the correlation with the item of which the appearance feature is input, the question determination unit 12 determines a question for inquiring about the color of the hat.

The correlation information may indicate that, for example, a plurality of items in which parts of the human body where appearance features appear have a predetermined relationship with each other are correlated with each other. In the “predetermined relationship”, the parts of the human body where the appearance features appear are the same as each other. For example, the parts of the human body where the appearance feature such as the items “presence or absence of hat”, “type of the hat”, “color of the hat”, “presence or absence of glasses”, “type of glasses”, “color of the glasses”, and “hairstyle” appear is the head. Accordingly, the correlation information may indicate that these items are correlated with each other. The correlation information may indicate that a plurality of items in which parts of the human body where appearance features appear are relatively close to each other are correlated to each other. For example, an operator of the processing device 10 can generate such correlation information and register the correlation information in the processing device 10.

Additionally, the correlation information may indicate that a plurality of items of which the features match are correlated with each other. For example, the features of the item “presence or absence of the hat” are a hat, presence or absence, and the like. The features of the item “type of hat” are a hat, a type, and the like. The features of the item “color of the hat” are a hat, color, and the like. The features of the item “presence or absence of glasses” are glasses, presence or absence, and the like. The features of the item “type of glasses” are glasses, types, and the like. The features of the item “color of glasses” are glasses, color, and the like. The features exemplified here are examples, and are not limited thereto. The correlation information may indicate that a plurality of items of at least one feature matches each other are correlated with each other.

For example, an operator of the processing device 10 can generate such correlation information and register the correlation information in the processing device 10. As another example, the operator may determine features for each item and register the features in the processing device 10. Then, the processing device 10 may specify a plurality of items of the features that match each other based on the registered information and may generate the correlation information based on a specification result.

Additionally, the correlation information may indicate that a plurality of items that have been input as a set in the past input have a correlation with each other. As another example, the correlation information may indicate that a plurality of items that have been input as a set a predetermined number of times or more in the past input have a correlation with each other.

In the case of this example, the above-described reception unit 11 can receive an input of appearance features of a plurality of items in a set. “Receiving an input of appearance features of a plurality of items in a set” means receiving an input of appearance features of a plurality of items collectively at a time. Means for implementing the input is not particularly limited. For example, by executing a predetermined operation (a press of a determination button or the like) in a state where appearance features of a plurality of items are filled in a predetermined input field on a UI screen, appearance features of the plurality of items filled in the input field during the operation may be input as a set.

In the case of this example, a history of content of the input received by the reception unit 11 is registered. The processing device 10 can specify a plurality of items that have been input as a set in the past input based on the history and generate the correlation information based on the specification result. Alternatively, the processing device 10 can specify a plurality of items that have been input as a set a predetermined number of times or more in the past input based on the history, and can generate the correlation information based on the specification result.

In a case where the appearance features of a certain item are stored by the witness, it is highly likely that the appearance features of another item correlated with the item as described above are stored by the witness. It is expected to obtain an answer of the appearance feature of the item at a high probability by questioning the witness about the appearance features of another item correlated with the input item of the appearance features as described above.

As a modification, the question determination unit 12 may extract an item that has no correlation with the item of which the appearance features are input based on the correlation information. Then, the question determination unit 12 may determine a question to inquire about the appearance features of the extracted item, specifically, the appearance features of the item of the tracking target person. By questioning the witness about the appearance features of the item of which the appearance features are input and the appearance features of another item that has no correlation as described above, there is a possibility of giving new awareness to the witness. As a result, it is expected to input new appearance features as an answer to the question.

Returning back to FIG. 1, the question unit 13 outputs a question determined by the question determination unit 12 and receives the answer to the question. As described above, the question determined by the question determination unit 12 questions about appearance features of a predetermined item. The answer to the question is “content of the appearance features” or “unknown (not remembered by the witness)”.

The question unit 13 outputs a question via an output device such as a display, a projection device, or a speaker. Then, the question unit 13 receives an answer to the question via an input device such as a keyboard, a touch panel, a microphone, or a physical button. The question unit 13 can implement an output of the question and the reception of an input of the answer via a predetermined UI screen. As the user who executes the input, a person who tracks the tracking target person, an affiliation member of an organization, or the like is assumed. The member checks the question output by the processing device 10. Then, the member reports the question to the witness by any means such as verbally, and obtains the answer to the question. Then, the member inputs the obtained answer to the processing device 10. As another example, the witness herself or himself may confirm a question output by the processing device 10 and input an answer to the processing device 10.

The search query generation unit 14 generates a search query for searching for the tracking target person in an image based on the answer to the question received by the question unit 13. The search query generation unit 14 can generate the search query based on the input content of the appearance features received by the reception unit 11 and the answer to the question received by the question unit 13.

The search query generation unit 14 generates the search query in which the input content of the appearance features received by the reception unit 11 and the appearance features of a plurality of items of the tracking target person indicated by the answer to the question received by the question unit 13 are connected by any logical operator. An example of the search query is “sex: male, age: thirties, presence or absence of hat: presence, a type of a hat: cap, and color of the hat: red”, or the like.

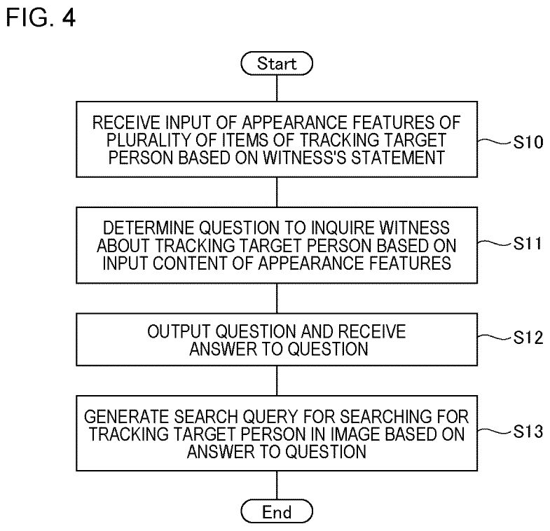

Next, an example of a flow of a process of the processing device 10 will be described with reference to the flowchart of FIG. 4.

The processing device 10 receives an input of appearance features of a plurality of items of the tracking target person based on the witness's statement (S10).

Subsequently, the processing device 10 determines a question to inquire the witness about the tracking target person based on the input content of the appearance features in S10 (S11). For example, the processing device 10 specifies an item of which the appearance features are input. Then, the processing device 10 extracts an item correlated with the specified item or an item not correlated with the specified item based on correlation information (see FIG. 3) indicating a correlation between the plurality of items. Then, the processing device 10 determines a question for inquiring about the appearance features of the extracted item. For example, the processing device 10 determines a question for inquiring about the color of the glasses, a question for inquiring the type of glasses, and the like.

Subsequently, the processing device 10 outputs the question determined in S11 and receives an answer to the question (S12). The answer to the question is “content of appearance feature” or “unknown (not remembered by the witness)”.

Subsequently, the processing device 10 generates a search query for searching for the tracking target person in the image based on the answer to the question (S13). For example, the processing device 10 generates a search query in which the appearance features of the plurality of items of the tracking target person indicated by the input content of the appearance features received in S10 and the answer to the question received in S12 are connected by any logical operator. An example of the search query is “sex: male, age: thirties, presence or absence of hat: presence, a type of a hat: cap, and color of the hat: red”, or the like.

### “Operations and Effects”

In the processing device 10 according to the present example embodiment, operational effects similar to those of the processing device 10 according to the first example embodiment are implemented.

In the processing device 10 according to the present example embodiment, it is possible to question the witness about the appearance features of another item correlated with the item of which the appearance features have been input. In a case where the appearance features of one item are remembered by the witness, it is highly likely that the appearance features of another item correlated with the item are remembered by the witness. It is expected to obtain an answer of the appearance features of the item with high probability by questioning the witness about the appearance features of such an item.

The processing device 10 according to the present example embodiment can treat a plurality of items in which parts of the human body where appearance features appear are the same as or close to each other as items that have correlation with each other. For example, in a case where a witness has seen and remembered appearance features of an item appearing on the head, the witness may have seen and remembered appearance features of another item appearing on the head. By determining a question based on such a correlation, it is expected to obtain the answer of the appearance features from the witness at a high probability.

The processing device 10 according to the present example embodiment can treat a plurality of items of which features match as items that have correlation with each other. For example, in a case where the witness remembers the appearance features of the item related to the “color” of the glasses, the witness may remember the appearance features of the item related to the “color” of the hat. In a case where the appearance features of the item related to the color of “glasses” are remembered by the witness, there is a possibility of the appearance features of the item related to the type of “glasses” being remembered by the witness. By determining a question based on such a correlation, it is expected to obtain the answer of the appearance features from the witness at a high probability.

The processing device 10 according to the present example embodiment can treat the plurality of items that have been input as a set in the past input as items that have correlation with each other. There is a possibility of the appearance features of the plurality of items remembered together by another witness also being remembered by the current witness. By determining a question based on such a correlation, it is expected to obtain the answer of the appearance features from the witness at a high probability.

Additionally, in the processing device 10 according to the present example embodiment, it is possible to question the witness about the appearance features of another item that has no correlation with the item of which the appearance features are input. A question about appearance features of another item that has no correlation with the input item may give new awareness to the witness. As a result, it is expected to obtain an answer of new appearance features from the witness.

### Third Example Embodiment

The processing device 10 according to the present example embodiment searches for the tracking target person using the search query generated by the search query generation unit 14. Details will be described below.

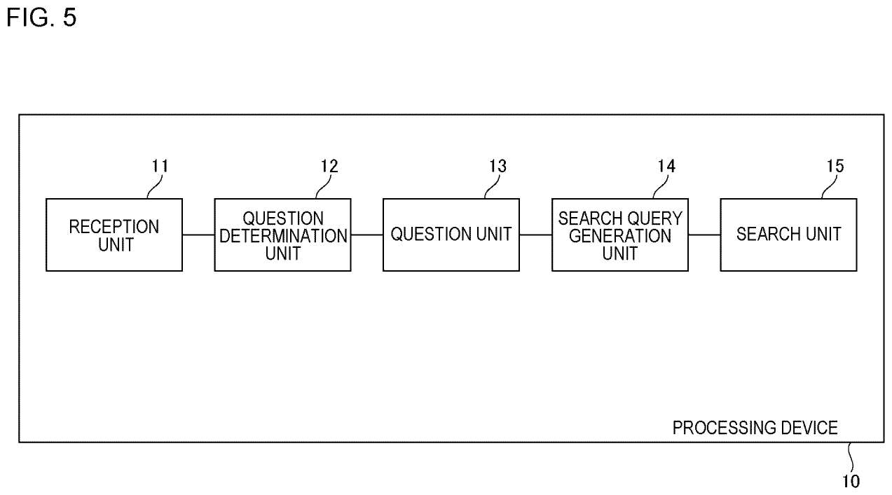

FIG. 5 illustrates an example of a functional block diagram of the processing device 10 according to the present example embodiment. As illustrated, the processing device 10 according to the present example embodiment includes the reception unit 11, the question determination unit 12, the question unit 13, the search query generation unit 14, and a search unit 15.

The search unit 15 searches for the tracking target person from the image using the search query generated by the search query generation unit 14. That is, the search unit 15 searches for a person satisfying a condition of the appearance features indicated by the search query generated by the search query generation unit 14 in the image. The searching is implemented using any technique. A search target image is input to the processing device 10 by any means. The image is a concept including a moving image and a still image.

Other configurations of the processing device 10 are similar to those of the first and second example embodiments.

According to the processing device 10 of the present example embodiment, operational effects similar to those of the first and second example embodiments are implemented. The processing device 10 according to the present example embodiment searches for the tracking target person using the search query generated by the characteristic scheme as described in the above example embodiment. According to the processing device 10, it is possible to accurately search for the tracking target person.

### Fourth Example Embodiment

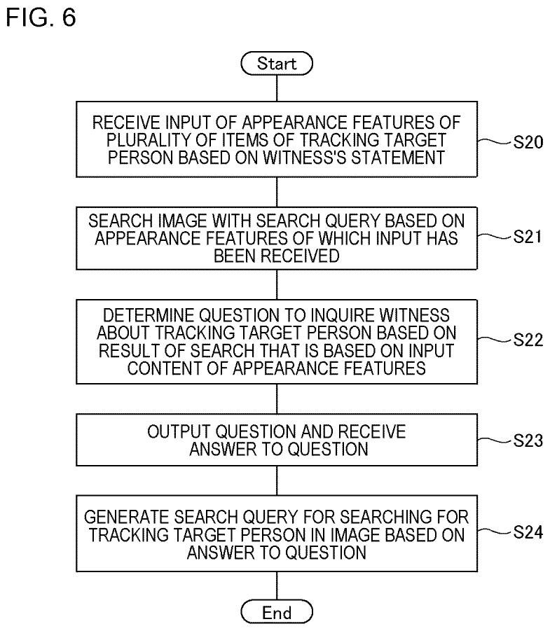

The processing device 10 according to the present example embodiment searches for the tracking target person in the image based on the appearance features of the plurality of items received by the reception unit 11, and determines a question to inquire the witness about the tracking target person based on the search result. Hereinafter, a configuration of the processing device 10 according to the present example embodiment will be described in detail with reference to the flowchart of FIG. 6.

The processing device 10 receives an input of the appearance features of the plurality of items of the tracking target person based on the witness's statement (S20). This step is implemented by the reception unit 11. Details of the step are as described in the second example embodiment.

Subsequently, the processing device 10 searches the image with the search query based on the appearance features of the tracking target person of which the input has been received in S20 (S21). This step is implemented by the search unit 15.

The search query used in the search may be a query in which the appearance features of the plurality of items of the tracking target person receiving the input in S20 are connected by any logical operator. The search query used in the search is different from the search query generated by the search query generation unit 14 in that the search query is generated based on the appearance features of the tracking target person receiving the input in S20, and the answer to the question determined by the question determination unit 12 is not reflected.

Subsequently, the processing device 10 determines a question to inquire the witness about the tracking target person based on a result of the search in S21 (S22). This step is implemented by the question determination unit 12.

The search result in S21 includes a plurality of images (still images or frame images) in which it is determined that the tracking target person appears. The question determination unit 12 analyzes each of the plurality of images and identifies appearance features of the person appearing in each image. Then, the question determination unit 12 determines a question based on the specification result.

For example, the question determination unit 12 can exclude an item satisfying a predetermined condition among the plurality of items from question targets.

The predetermined condition is, for example, “from all the plurality of images, appearance features having the same content are specified”. Even when appearance features of such items are questioned to the witness, it is not effective for narrowing down search results.

Additionally, the predetermined condition is, for example, “from a predetermined ratio or more of the plurality of images, appearance features having the same content are specified”. Even when the appearance features of such items are questioned to the witness, it is not so effective for narrowing down search results.

Conversely, in the item not satisfying the predetermined condition as described above, it is considered that the content of the appearance features specified from the plurality of images varies. The appearance features of such items are effective for narrowing down the search results. Accordingly, the question determination unit 12 determines a question to inquire about appearance features of an item that are appearance features of the tracking target person and do not satisfy the predetermined condition as described above.

Subsequently, the processing device 10 outputs the question determined in S22 and receives an answer to the question (S23). This step is implemented by the question unit 13. Details of the step are as described in the second example embodiment.

Subsequently, the processing device 10 generates a search query for searching for the tracking target person in the image based on the answer to the question (S24). This step is implemented by the search query generation unit 14. Details of the step are as described in the second example embodiment.

Other configurations of the processing device 10 are similar to those of the first to third example embodiments.

According to the processing device 10 of the present example embodiment, operational effects similar to those of the first to third example embodiments are implemented. The processing device 10 according to the present example embodiment searches for the tracking target person in the image based on the appearance features of the plurality of items received by the reception unit 11, and determines the question to inquire the witness about the tracking target person based on the search result. In the processing device 10, it is possible to determine a question regarding an item effective for narrowing down the search results. As a result, a search query with which it is possible to accurately search for the tracking target person can be generated.

### Modifications

The modification is applicable to the first to fourth example embodiments. The question determination unit 12 determines a question by the scheme described in the second example embodiment. That is, the question determination unit 12 determines a question for inquiring about the appearance features of an item correlated with the item of which an input of the appearance features is received by the reception unit 11.

In a case where there are a plurality of questions determined by the question determination unit 12, the question unit 13 preferentially inquires questions for inquiring about appearance features of an item correlated with more items among the items for which the reception unit 11 has received the input of appearance features.

For example, it is assumed that the reception unit 11 receives the inputs of the appearance features of the first to third items. It is assumed that the question determination unit 12 determines questions for inquiring about the appearance features of the fourth and fifth items. The fourth item is correlated with the first item, and the fifth item is correlated with the first and second items. In this case, the fifth item is correlated with more items among the items (first to third items) for which the input of the appearance feature has been received by the reception unit 11 than the fourth item. Therefore, the question unit 13 makes a question about the appearance feature of the fifth item in preference to a question about the appearance feature of the fourth item.

Here, “preferentially inquiring” will be described. For example, in a case where a plurality of questions is arranged and output on a screen, the questions to be inquired preferentially are arranged first. In a case where a plurality of questions are sequentially output to the screen by a predetermined number, the questions to be inquired preferentially are output first.

In the modification, the same effects as those of the above example embodiment are also implemented. In a case where a plurality of questions are determined, the processing device 10 can prioritize and output the questions. As a result, for example, it is possible to more preferentially inquire about a question strongly related to the appearance features input by the reception unit 11 and is highly likely to be remembered by the witness.

Although the example embodiments of the present invention have been described above with reference to the drawings, these are examples of the present invention, and various configurations other than the above can also be used. The configurations of the above-described example embodiments may be combined with each other, or some of the configurations may be replaced with other configurations. The configurations of the above-described example embodiments may be modified in various forms within a range without departing from the gist. The configurations and processes disclosed in the above-described example embodiments and modifications may be combined with each other.

In the plurality of flowcharts used in the above description, a plurality of steps (processes) are described in order. However, an execution order of the steps executed in each example embodiment is not limited to the described order. In each example embodiment, the order of the illustrated steps can be changed within a range in which there is no problem in terms of content. The above-described example embodiments can be combined within a range in which the contents are not contradictory.

Some or all of the above example embodiments may be described as the following supplementary notes, but are not limited to the following.

1. A processing device including:
reception means for receiving an input of appearance features of a plurality of items about a tracking target person based on a witness's statement;
question determination means for determining, based on an input content of the appearance features, a question to inquire the witness about the tracking target person;
question means for outputting the question and receiving an answer to the question; and
search query generation means for generating a search query for searching for the tracking target person in an image based on the answer to the question.

2. The processing device according to 1, wherein the search query generation means generates the search query based on the input content of the appearance features and the answer to the question.

3. The processing device according to 1 or 2, wherein the question determination means specifies the item of which the appearance feature has been input, and determines the question based on the specified item.

4. The processing device according to 3, wherein
the question determination means
extracts the item correlated with the specified item or the item not correlated with the specified item based on correlation information indicating a correlation between the plurality of the items, and
determines the question for inquiring the appearance feature of the extracted item about the tracking target person.

5. The processing device according to 4, wherein the correlation information indicates that a plurality of the items in which parts of a human body where the appearance features appear have a predetermined relationship with each other are correlated with each other.

6. The processing device according to 4 or 5, wherein the correlation information indicates that a plurality of the items of which features match are correlated with each other.

7. The processing device according to any one of 4 to 6, wherein the correlation information indicates that a plurality of the items that are input as a set in the past input have a correlation with each other. 8. The processing device according to any one of 1 to 7, wherein the question determination means determines the question based on a search result of the tracking target person in the image based on the appearance feature of which the input is received.

9. A processing method causing one or more computers to execute:
receiving an input of appearance features of a plurality of items about a tracking target person based on a witness's statement;
determining, based on an input content of the appearance features, a question to inquire the witness about the tracking target person;
outputting the question and receiving an answer to the question; and
generating a search query for searching for the tracking target person in an image based on the answer to the question.

10. A program that causes a computer to function as:
reception means for receiving an input of appearance features of a plurality of items about a tracking target person based on a witness's statement;
question determination means for determining, based on an input content of the appearance features, a question to inquire the witness about the tracking target person;
question means for outputting the question and receiving an answer to the question; and
search query generation means for generating a search query for searching for the tracking target person in an image based on the answer to the question.

This application is based upon and claims the benefit of priority from Japanese patent application No. 2023-052946, filed on Mar. 29, 2023, the disclosure of which is incorporated herein in its entirety by reference.

### REFERENCE SIGNS LIST

10 processing device
11 reception unit
12 question determination unit
13 question unit
14 search query generation unit
2A memory
3A input/output I/F
4A peripheral circuit
5A bus

What is claimed is:

1. A processing apparatus comprising:
at least one memory configured to store one or more instructions; and
at least one processor configured to execute the one or more instructions to:
receive an input of appearance features of a plurality of items about a tracking target person based on a witness's statement;
determine, based on an input content of the appearance features, a question to inquire the witness about the tracking target person;
output the question;
receive an answer to the question; and
generate a search query for searching for the tracking target person in an image based on the answer to the question.

2. The processing apparatus according to claim 1, wherein
the at least one processor is further configured to execute the one or more instructions to generate the search query based on the input content of the appearance features and the answer to the question.

3. The processing apparatus according to claim 1, wherein
the at least one processor is further configured to execute the one or more instructions to specify the item of which the appearance feature has been input, and determine the question based on the specified item.

4. The processing apparatus according to claim 3, wherein
the at least one processor is further configured to execute the one or more instructions to
extract the item correlated with the specified item or the item not correlated with the specified item based on correlation information indicating a correlation between the plurality of the items, and
determine the question for inquiring the appearance feature of the extracted item about the tracking target person.

5. The processing apparatus according to claim 4, wherein the correlation information indicates that a plurality of the items in which parts of a human body where the appearance features appear have a predetermined relationship with each other are correlated with each other.

6. The processing apparatus according to claim 4, wherein the correlation information indicates that a plurality of the items of which features match are correlated with each other.

7. The processing apparatus according to claim 4, wherein the correlation information indicates that a plurality of the items that are input as a set in the past input have a correlation with each other.

8. The processing apparatus according to claim 1, wherein
the at least one processor is further configured to execute the one or more instructions to determine the question based on a search result of the tracking target person in the image based on the appearance feature of which the input is received.

9. A processing method causing one or more computers to execute:
receiving an input of appearance features of a plurality of items about a tracking target person based on a witness's statement;
determining, based on an input content of the appearance features, a question to inquire the witness about the tracking target person;
outputting the question;
receiving an answer to the question; and
generating a search query for searching for the tracking target person in an image based on the answer to the question.

10. The processing method according to claim 9, wherein the one or more computers generate the search query based on the input content of the appearance features and the answer to the question.

11. The processing method according to claim 9, wherein the one or more computers specify the item of which the appearance feature has been input, and determine the question based on the specified item.

12. The processing method according to claim 11, wherein
the one or more computers
extract the item correlated with the specified item or the item not correlated with the specified item based on correlation information indicating a correlation between the plurality of the items, and
determine the question for inquiring the appearance feature of the extracted item about the tracking target person.

13. The processing method according to claim 12, wherein the correlation information indicates that a plurality of the items in which parts of a human body where the appearance features appear have a predetermined relationship with each other are correlated with each other.

14. The processing method according to claim 12, wherein the correlation information indicates that a plurality of the items of which features match are correlated with each other.

15. A non-transitory computer-readable medium storing a program that causes a computer to:
receive an input of appearance features of a plurality of items about a tracking target person based on a witness's statement;
determine, based on an input content of the appearance features, a question to inquire the witness about the tracking target person;
output the question;
receiving receive an answer to the question; and
generate a search query for searching for the tracking target person in an image based on the answer to the question.

16. The non-transitory computer-readable medium according to claim 15, wherein the program causes the computer to generate the search query based on the input content of the appearance features and an the answer to the question.

17. The non-transitory computer-readable medium according to claim 15, wherein the the program causes the computer to specify the item of which the appearance feature has been input, and determine the question based on the specified item.

18. The non-transitory computer-readable medium according to claim 17, wherein
the program causes the computer to extract the item correlated with the specified item or the item not correlated with the specified item based on correlation information indicating a correlation between the plurality of the items, and
determine the question for inquiring the appearance feature of the extracted item about the tracking target person.

19. The non-transitory computer-readable medium according to claim 18, wherein the correlation information indicates that a plurality of the items in which parts of a human body where the appearance features appear have a predetermined relationship with each other are correlated with each other.

20. The non-transitory computer-readable medium according to claim 18, wherein the correlation information indicates that a plurality of the items of which features match are correlated with each other.
